(19) United States
(12) Patent Application Publication
(10) Pub. No.: US 2010/0046198 A1
(43) Pub. Date: Feb. 25, 2010

(54) Flexible Backlit Display

(75) Inventor: Brian E. Hoffman, Pasadena, MD (US)

Correspondence Address: EDELL, SHAPIRO & FINNAN, LLC, 1901 RESEARCH BOULEVARD, SUITE 400, ROCKVILLE, MD, 20850, US

(73) Assignee: NIGHT MOVES, LLC, Hanover, MD (US)

(21) Appl. No.: 12/545,321

(22) Filed: Aug. 21, 2009

Related U.S. Application Data
(60) Provisional application No. 61/090,711, filed on Aug. 21, 2008.

(51) Int. Cl. F21V 9/16; H01J 9/00; G09F 13/04; H01J 1/62

(52) U.S. Cl. 362/84; 445/24; 362/97.1; 313/498

(57) ABSTRACT

The present invention is directed toward a graphics display assembly configured to display a true color palette in illuminated and non-illuminate states. The graphics display assembly includes a backlit electroluminescent (EL) panel and optical interface layer. The optical interface layer is translucent, preventing color shift of transmitted light. In operation, the optical interface layer masks the pink or rose-colored hue visible when the EL panel is in its non-illuminated state.

### CROSS REFERENCE TO RELATED APPLICATIONS

This application claims priority to U.S. Provisional Application No. 61/090,711, filed 21 Aug. 2008 and entitled “Display Assembly with Optical Interface Layer,” the disclosure of which is hereby incorporated by reference in its entirety.

### FIELD OF THE INVENTION

The present invention relates generally to advertising and signage displays and devices, and, in particular, to a true color day/night backlit display assembly including an optical interface layer.

### BACKGROUND OF THE INVENTION

Out-of-home (outdoor) advertising and signage represents a significant and growing segment of annual overall commercial media spending. In order to catch and hold the attention of consumers, out-of-home advertising relies on attractive, full-color imagery and text. Illuminated outdoor advertising is an essential part of out-of-home advertising. Illuminated outdoor advertising includes advertising indicia that is, itself, a passive display that must be illuminated in order to be seen, either by natural lighting during the day or by some light source in times of darkness.

Two types of outdoor advertising systems include front lighting illumination systems and backlighting illumination systems displays. Front lighting illumination systems include incandescent and halogen lamps, as well as light emitting diode (LED) arrays mounted in front of the advertising indicia to shine light on the front of the display. The viewer sees the advertising image by this reflected light.

Backlighting illumination systems include fluorescent lights and LED arrays mounted behind the advertising indicia, which is printed with translucent inks on translucent materials that let the light pass through the display directly to the viewer. Each of the backlighting illumination sources possesses disadvantages such as energy consumption, heat generation, fragility, and maintenance cost (due, in part, to bulb/ballast replacement and maintenance). These illumination sources also pose challenges for advertising device designers and installers because the light bulbs, sockets, frames, and mounting hardware are large, heavy and rigid.

This has given rise to the use of electroluminescent (EL) panels as a source of backlight illumination for these advertising signs and devices. EL panels were initially available with green or blue hues, thus the phosphor layer included a blue/green phosphor mix. To provide EL panels capable of generating a white mono-color when illuminated, a family of compositions was developed based on a blue-green phosphor mix, but further included a red component (e.g., Europium or Manganese).

Backlit EL panels, however, are limited in their ability to provide true color presentations. A typical image layer or substrate (onto which graphics are printed) applied directly to the EL panel allows the internal light generated by the EL panel to pass through the substrate without being altered (i.e., without any ‘color shift’ occurring) so that the viewer sees the advertising display as the designer intended. Thus, when the EL panel is energized, the light it emits (and any incident external light) combines to provide the desired visual image.

While light from the EL panel can pass outward through the substrate and inks printed thereon, light from external sources (i.e., sunlight, other artificial light sources in proximity of the panel) are also permitted to pass inward, through the substrate, ultimately being reflected back by surfaces within the EL panel. Outdoor advertising displays incorporating EL panels as the backlight source are not typically energized during periods of sunlight, since doing so would degrade the phosphors used in the EL panel and shorten the panel's operating life. Leaving the EL backlight source off during periods of sunlight, however, allows the external light to penetrate inward through the substrate and reflect back off the EL panel in the assembly. This external light interacts with the red component, creating a color shift in the EL panel. When this occurs, EL panels that are designed to produce white light when energized appear off-white, having a reddish, pink, or rose color when the power is off.

Thus, the red component, while producing a clean white mono-color light when the EL panel is energized, causes the panel to appear discolored when the power is off. This pink hue can be seen through the image layer when viewed during periods of daylight, seriously degrading the true color capability of any day/night advertising device backlit with an EL panel.

Thus, it is desirable to provide a day/night electroluminescent display capable of rendering a clean white color, and is capable of eliminating the pink hue that occurs when the display is not illuminated.

### SUMMARY OF THE INVENTION

The present invention is directed toward a flexible day/night backlit graphics display assembly configured to display a true color palette in illuminated (energized) and non-illuminated (non-energized) states. The backlit display assembly includes an electroluminescent (EL) panel, an image layer, and an optical interface layer disposed between the image layer and the EL panel. The optical interface alters the angle of incidence of the external light entering panel, preventing the color shift that occurs when the panel is in its non-energized state. In operation, the optical interface layer enables the panel to display a clean white light regardless of the energy state of the EL panel.

### BRIEF DESCRIPTION OF THE DRAWINGS

FIG. 1 illustrates an exploded view of a flexible backlit display assembly in accordance with an embodiment of the invention.

FIG. 2 illustrates a cross-sectional view of a flexible electroluminescent panel of FIG. 1 in accordance with an embodiment of the invention.

FIG. 3 illustrates a cross-sectional view of the assembly of FIG. 1.

FIG. 4 illustrates the assembly of FIG. 3, further including optional masking and protective layers.

### DETAILED DESCRIPTION OF THE INVENTION

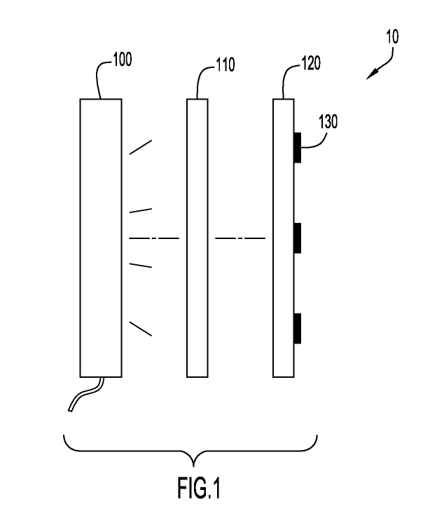

FIG. 1 illustrates a flexible backlit graphics display assembly in accordance with an embodiment of the invention. As illustrated, the display assembly 10 includes an electroluminescent (EL) subassembly or panel 100, an optical interface layer 110, and an image layer or substrate 120 including an image 130 printed thereon. The display assembly 10 operates in a first, non-illuminated state, in which the electroluminescent panel 100 is extinguished, and a second, illuminated state, in which the electroluminescent panel is energized. In operation, the EL panel 100 is typically extinguished during hours when sunlight is available, and is illuminated/energized during nighttime hours (and/or when the signage is located inside). The display assembly 10 is operable to display printed graphics 130 and other signage to a user viewing the front (outward) surface of the display (i.e., of the image layer 120).

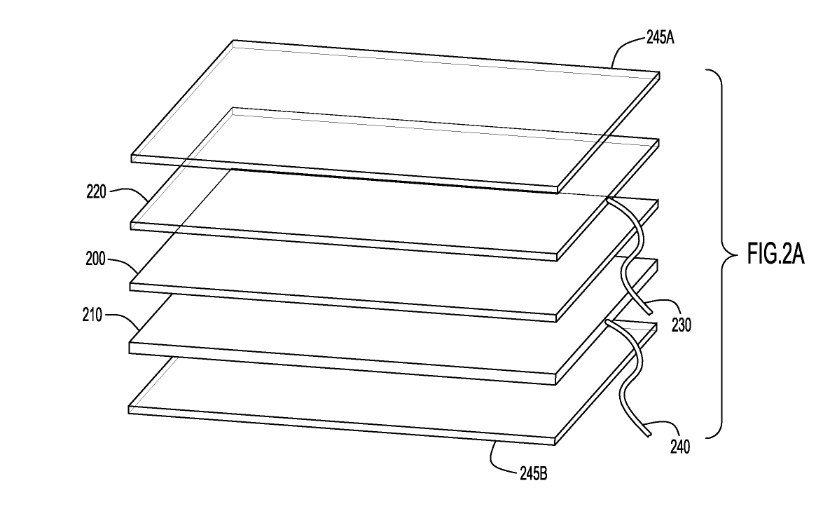

The electroluminescent panel 100 may be a conventional electroluminescent panel including a conformable and/or flexible construction. FIG. 2A shows a parallel plate EL panel, which includes a thin, flexible, and conformable sandwich construction including an electroluminescent or phosphorescent layer 200 bonded between a rear or opaque electrode layer 210 and a front or transparent electrode layer 220. The transparent electrode 210 may include a polymeric layer having a high degree of optical transparency (e.g., an indium tin oxide (ITO) coated polyester film). Contacts 230 and 240 may be fitted to the electrodes 210, 220 to energize the lamp with a high frequency alternating current source (e.g., 100-150 V). An outermost protective film 245A, 245B (e.g., a transparent polyester film) may encase the components to create a barrier to moisture, dust, etc. With this configuration, the transparent electrode layer 220 defines the light transmission side of the EL panel 100 since the transparent electrode and the transparent protective film are each light transmission layers. The opaque electrode layer 210, in contrast, defines the opaque side of the EL panel 100.

FIG. 2B shows a split electrode EL panel 100 construction including the same transparent electrode 205 and phosphor layer 200 as described above; however the opaque electrode 210 is split into a first electrode portion 250A and a second electrode portion 250B. Contacts 230 and 240 may be fitted to the electrodes 250A, 250B to energize the lamp with a high frequency alternating current source (e.g., 200-280 V). As with the above described construction, the EL panel 100 may further include an outer protective layer (e.g., transparent polyester films) that creates a barrier to moisture, dust, etc. (not illustrated).

EL panels 100 are typically thin, having thickness of less than 0.10 inches (2.4 mm). The panels 100 can be manufactured in strips of varying lengths and widths (e.g., of 30 inches or more). The EL panels 100, moreover, are flexible. As such, the panels are capable of conforming to predetermined topographical features. For example, EL panels 100 are capable of wrapping around columns, being fit to curved walls, and are capable of withstanding the stresses and constant flexing of mobile vehicle advertising. By way of specific example, commercially available EL panels that produce white light may be utilized, such as FlatLite® manufactured by E-Lite Technologies, Inc. (Trumbull, Conn.) and Light Tape® from Electro-LuminX (Chester, Va.).

The phosphorescent layer 200 of the EL panel 100 may include particles of an electroluminescent phosphor embedded in a transparent flexible binder. As noted above, conventional green/blue EL panels utilize a mix of natural blue/green phosphor crystals as the electroluminescent phosphor. This type of phosphor, when energized, generates a blue/green light. The phosphor mix of a white-light-generating EL panel further includes a red component (e.g., a Europium oxide or a red dye) to shift the blue/green color toward white. Thus, when the phosphorescent layer 200 is energized, the EL panel generates a white light (e.g., a cool white light having a temperature of about 5400-8000 K).

However, when the EL panel 100 is not energized, the red component in phosphorescent layer 200 causes the EL panel (via the transparent electrode 220) to appear discolored. That is, while the red component combines with the other phosphors to produce the clean white, mono-color light emitted from the EL panel 100 when energized, it also produces a discoloration (i.e., the pink- or rose-colored appearance) in the EL panel 100 when the power to the panel is extinguished. These types of EL panels are typically called “pink off/white on” panels as a result of this discoloration.

This discoloration is caused by a color shift that is created when light from an external source enters with the EL panel 100 and interacts with the red component of the phosphorescent layer 200. In the non-illuminated state, light from an external source (e.g., sunlight or a light source exterior the display assembly 10) enters the light transmission side of the EL panel 100, reflecting within the panel and interacting with the phosphor components to cause a color distortion. This color distortion results in a pink- or rose-colored hue in the EL panel 100 which, in turn, color distorts the image layer 120. This discoloration is visible through any image layers 120 applied to the light transmission side of the panel (i.e., through any layers oriented over the front of the panel). As a result, a sign that appears paper white when illuminated appears reddish when extinguished/darkened. This, in turn, seriously degrades the true color capability of any day/night advertising device backlit with an EL panel. To produce true color displays, a clean white color (e.g., a white color having a CIE chromatic coordinates x≈0.3 and y≈0.3) is preferred.

The optical interface layer 110 is configured to prevent the discoloration visible when the EL panel 100 is in its non-illuminated state, as well to maintain the clean white light generated when the EL panel is illuminated. The optical interface layer 110 may be in the form of a flexible film positioned over the light emitting side of the EL panel 100 (e.g., applied to the transparent electrode 220 or to the protective layer 245A (when present)). The optical interface layer 110 is selected to alter the angle of incidence and reflection of light entering from an external source (e.g., sunlight) to a degree effective to prevent the discoloration. Thus, the optical interface layer 110 is translucent, permitting light to pass through the layer, but diffusing the light as it travels through the film.

In addition, the optical interface layer 110 prevents any color shift in the mono-color white light emitted by the EL panel 100 from occurring. To achieve this, the translucency of the optical interface layer must be maintained so as not degrade the luminance value of the monocolor white light emitted by the EL panel 100. In a preferred embodiment, the optical interface layer 110 reduces the luminance value of the monocolor white light coming from the energized EL panel 100 by no more than 30%. Stated another way, the interface layer 110 permits approximately 70% or more of the light from the EL panel 100 to pass through to the image layer 120. With this configuration, the optical interface layer 110 does not destroy the ability of the EL panel 100 to function as an illumination source for the image layer 120.

The optical interface layer 110 may be formed from a polyvinyl chloride (PVC) film bonded to the front surface of the EL panel 100. Alternatively, the optical interface layer 110 may be formed from an acid- or acid/acrylate-modified ethylene vinyl acetate (EVA) polymeric resin. This modified EVA resins may be present in the optical layer in an amount of at least 60% by weight, and preferably in an amount of about 70% by weight. These types of modified EVA films are generally disclosed in U.S. Pat. No. 5,721,086, the contents of which are hereby incorporated by reference in its entirety. By way of example, the optical interface layer 110 may possess a thickness of no more than approximately 4 mil (0.10 mm).

The optical interface layer 110 may be a single film, or may include a plurality of thin film layers bonded into one composite layer, depending upon the specific application. In the case of multiple layers, each layer should reduce the luminance value of the monocolor white light coming from the energized EL panel 100 by no more than about 30%. By selecting the appropriate materials and thicknesses for the layers, the resulting composition adds an intervening optical interface (between the observer and the EL panel illumination source) that changes the angle of incidence and reflection of the external light source (e.g., sunlight) impacting/entering the light transmitting side of the EL panel 100 to a degree sufficient to eliminate the discoloration (e.g., the red tint) visible to a viewer. In a preferred embodiment, the layer is white in apparent color to the observer.

The optical interface layer 110, furthermore, may possess a predetermined coefficient of elasticity to enable it to conform to the front surface of the EL panel 100 without limiting the flexibility or “hand” of the EL panel. The optical interface layer 110 may possess a tensile strength of 2.3 kg/cm at 23° C. to prevent tearing of the layer while flexing. In a preferred embodiment, the optical interface layer 110 is white in apparent color to the observer. Preferably, the optical interface layer 110 possesses a matte finish (gloss <10 at 60° angle).

By way of specific example, the optical interface layer is a Controltac® 160-60 vinyl film, commercially available from 3M® (St. Paul, Minn.). A single layer of 3M® 160-60 film reduces the luminance value from the EL panel by approximately 28% (permitting 72% of the light from the uncovered EL panel to be transmitted).

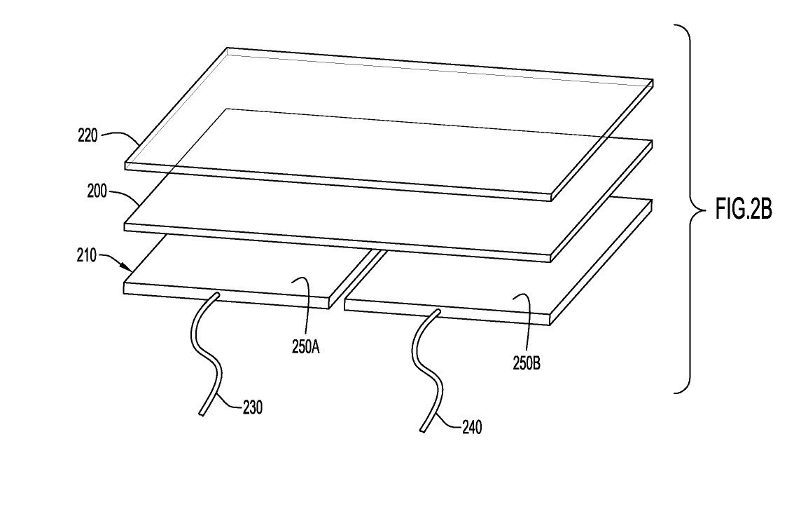

The optical interface layer may be secured to the front surface of the EL panel via an adhesive. With specific reference to FIG. 3, an adhesive layer 300 is incorporated between the rear surface of the optical interface layer 110 and the front surface of the EL panel 100. The adhesive forming the adhesive layer 300 may possess a degree of translucency equal to or greater than that of the optical interface layer 110. Preferably, the adhesive is optically transparent. The adhesive is formed from material that does not yellow or otherwise degrade when exposed to sunlight or ultraviolet radiation so as not to cause a color shift in the mono color white light emitted by the EL panel 100.

By way of example, an acrylic, pressure-activated adhesive (PAA) may be utilized for the adhesive layer 300. The optically clear adhesive layer possesses a thickness of about 0.5-1 mil thick (preferably 0.5 mil) to keep the overall thickness to a minimum. A PAA is preferred over a thermally activated adhesive due to the fact that the excess heat required to promote bonding could damage the phosphors in the EL panel itself. Similarly, a chemically activated adhesive can degrade the plastic laminate protecting those phosphors.

The flexible image or graphics layer 120 is a printable or printed film that carries the graphics ultimately displayed to a viewer of the display assembly 10 in sunlight and backlit conditions. The image layer 120 may be transparent. Alternatively, as with the optical interface layer, the image layer 120 may be translucent, permitting the passage of light, but diffusing it while it passes through the film. The image layer 120 should be configured reduce the luminance value of the light generated by the EL panel 100 by no more than 30% (e.g., approximately 28%), thus permitting approximately 70% of the light from the uncovered EL panel 100 to be transmitted therethrough. The material forming the substrate includes, but is not limited to, vinyl. The outward-facing (front) surface of the image layer 120 defines a print receiving surface. An optically clear pressure sensitive adhesive layer 310 similar to that described above secures the rear surface of the image layer 120 to the front surface of the optical interface layer 110. The image layer 120 preferably possesses a thickness of about 4 mil (0.10 mm).

By way of specific example, the image layer 120 may be Controltac® 160-60, a commercially-available calendered vinyl film from 3M® (St. Paul, Minn.).

The image 130 on the image layer 120 may be formed utilizing conventional printing processes and inks (UV and/or solvent based inks). For example, images may be translucent images (formed via translucent inks) printed on one side of the image layer 120 or on opposite sides of the layer.

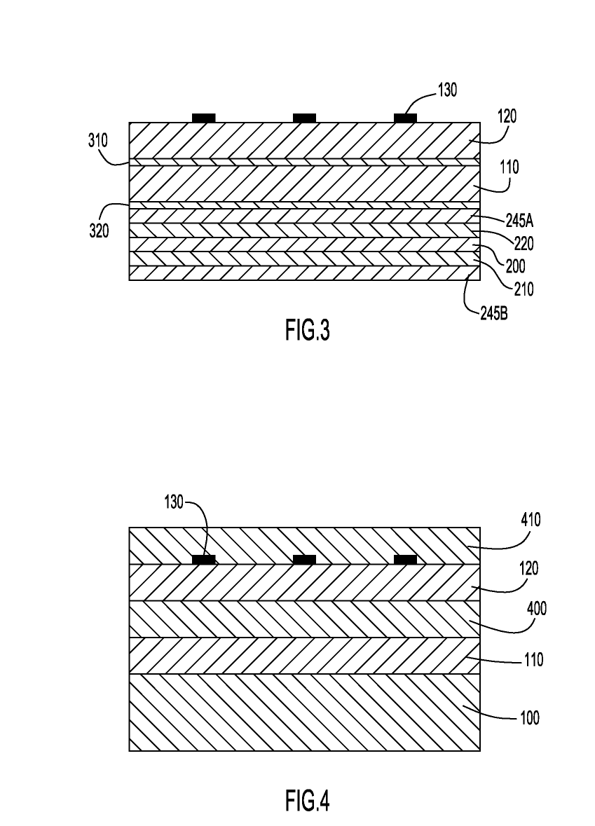

FIG. 4 illustrates a backlit display assembly 40 in accordance with another embodiment of the invention. As illustrated, the backlit display assembly 40 further includes an optional masking layer 400 oriented between the optical interface layer 110 and the image layer 120. Specifically, the masking layer 400 may be secured to the optical interface layer 110, with the image layer 120 being secured to the masking layer 400 (e.g., via conventional pressure sensitive adhesives (adhesive layers not illustrated for clarity)). The masking layer 400, opaque to visible light, may cover a portion of the front surface of the EL panel 100. The masking layer 400 may be shaped to form a stencil effect over the surface of the optical interface layer 110, making the resulting backlight generated by the EL panel 100 appear as a symbol, letter, or some other desired design when the power is on.

The masking layer 400 may be formed from a variety of materials including an optically opaque film having, e.g., a light transmission of less than about 0.005% and, preferably, about 0.001%. In a preferred embodiment, the masking layer 400 is white in color so that the masking layer, in blocking the emitted light from the EL panel 100, does not itself alter the color of any overlying graphics. By way of specific example, the masking film has a white face side with a matte surface and an opposed side coated with pressure sensitive adhesive. The thickness of the masking layer may be approximately 0.1 to 0.14 mm thick (film and adhesive).

One example of a suitable, commercially-available masking layer is the ARLON 5570 block-out film (Arlon, Inc., Santa Ana, Calif.). This optically opaque film is fully conformable, is available in “book white” color and is provided with a pressure-activated adhesive. Another example is the 3635 series of Light Management (Blockout) Films available from 3M® (St. Paul, Minn.).

In addition, the display assembly 40 may include an optional protective or overlaminate layer 410 secured to the image layer 120. The overlaminate layer 410 provides a barrier to moisture, dust, etc. The overlaminate layer 410 may be in the form optically transparent, cast vinyl overlaminate film with a luster finish. The film may have a thickness of, e.g., 2 mil. The overlaminate layer 410 may be secured to the image layer 120 via an adhesive layer similar to that described above (not illustrated). By way of specific example, commercially available overlaminatex are Scotchcal™ Luster Overlaminates available from 3M® (St. Paul, Minn.).

All elements of the backlit display assembly 10, 40 are flexible such that the display assembly can be formed to fit and closely follow, or conform to, the contours of any selected substrate, including, but not limited, to recessed, rippled, ribbed, riveted or corrugated sides of rigid sided cargo trailers, train cars and other vehicles, and stationary wall structures. Preferably, the display assembly 10, 40 may be configured to bend at least about 90° without destroying the adhesive bonds, reducing the optical transmission characteristics, or destroying light emission characteristics of the display assembly. Preferably, the display assembly 10, 40 has a bending radius of 0.5 inches. As a result, the display assembly 10, 40 may be conformably bonded to fabric sidewalls vehicles, or may extend around right angle bends between side and rear walls of a vehicle. Stated another way, the display assembly 10, 40 is conformable and flexible to permit attachment to curved substrates, corrugated substrates, flexible substrates, and/or substrates with irregular surfaces defined by sharply raised areas.

Thus, the present invention provides a flexible display module that comprises the EL panel 100 and the translucent optical interface layer 110 that masks the reddish hue of the EL panel. Neither the optical interface layer 110 nor the adhesive selected degrade the insulating properties or otherwise interfere with the laminate that encapsulates the phosphors of the EL panel 100 and, in fact, can add another moisture barrier to protect said components.

The present invention simplifies the design and fabrication of advertising displays and devices by providing a self-contained, EL-panel-based, backlight illumination display module that can be inserted behind any advertising presentation without concern for the day/night true color performance of the resulting assembly. The above-described configuration does not have to be further modified or treated to deliver the clean white mono-color appearance required when on or off. In addition, the advertising presentation itself, such as graphics printed directly on a polycarbonate sheet, does not have to be modified with a diffuser or similar apparatus as the proposed invention provides the processed backlit directly.

Being self-contained, the present invention can be used to illuminate both long dwell time signage and short dwell time promotional advertising. In each case, the advertising indicia to be backlight can be swapped out and the module reused behind another display without concern for color shifts or other issues affecting the true color day/night performance of the assembly.

The present invention provides a true color day/night graphic display having substantially equivalent spectral content in both the illuminated and non-illuminated states. That is, the imaged layer 120 possesses substantially equivalent spectral content when illuminated by an external light source (i.e., a light source located in front of the display 10, 40) such as sunlight as when illuminated by the internal light source located behind the display (i.e., the EL panel 100). With the above described configuration, the material forming the optical interface layer 110 does not cause a color shift of the mono-color white light emitted by the EL panel 100 itself or in any other way corrupt the true color performance of the day/night advertising display while powered or with the power off. Thus, the resulting display is capable of presenting a nearly clean white color to the viewer (e.g., “paper white” having approximate CIE chromatic coordinates x≈0.3 and y≈0.3).

While the present invention has been described in detail and with reference to specific embodiments thereof, it will be apparent to one skilled in the art that various changes and modifications can be made therein without departing from the spirit and scope thereof. For example, the EL panel 100 may include, but is not limited to, conventional “pink off/white on” panels of various configurations. While parallel plate and split electrode EL panels are discussed, other EL panel constructions may be utilized including bus bar constructions such as those disclosed in U.S. Published Patent Application No. 2005/0124258 (Appelberg et al.), the disclosure of which is hereby incorporated by reference in its entirety. The phosphors of the El panel 100 may include encapsulated or un-encapsulated phosphors.

In addition, the optical interface layer 110 may be printable or non-printable. When printable, true color advertising presentations (graphics and/or text) can be printed (using the translucent inks noted above) directly on the outer front surface of the optical interface. This eliminates the need in some applications for a separate substrate to carry the advertising presentation. The image layer 120 may be treated further to improve printing properties of its surface (e.g., coatings, corona treatment, etc.).

In addition, while optically transparent adhesive is preferred, other techniques may be utilized to secure components of the display assembly together, including, but not limited to, application tape.

Thus, it is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

What is claimed:

1. A color day-night backlit display assembly comprising:
a conformable and flexible electroluminescent panel including:
a first electrode layer defining an opaque side of the panel,
a second, transparent electrode layer defining a light transmission side of the panel, and
an electroluminescent layer oriented between the first electrode and second electrode,
wherein the electroluminescent panel is operable in a first, energized state, in which clean white light is produced, and a second, non-energized state, in which no light is produced by the panel, and wherein, in the energized state, the light transmission layer appears a first color to a viewer of the panel and, in the non-energized state, the light transmission layer appears a second color to the viewer of the panel; and
a translucent, flexible optical interface layer coupled to the light-transmission side of the electroluminescent panel, wherein, when the panel is in its non-energized state, the optical interface layer shifts the color of the light transmission layer from the second color to the first color.

2. The backlit display of claim 1, wherein the optical interface layer alters the path of incident light from an external light source to cause the color shift from the second color to the first color.

3. The backlit display assembly of claim 2, wherein the optical interface layer reduces the luminance value of the white light generated by the energized EL panel by no more than 30%.

4. The backlit display assembly of claim 1, wherein the first color is white and the second color is a red tint generated by a phosphor component contained in the electroluminescent layer.

5. The backlit display assembly of claim 1 further comprising an optically transparent pressure sensitive adhesive that secures the optical interface layer to the electroluminescent panel.

6. The backlit display assembly of claim 1, further comprising an imaged layer disposed over and connected to the optical interface layer, the imaged layer including a graphic printed on portion of its surface.

7. The backlit display assembly of claim 6, wherein the non-printed portions of the imaged layer reduces the luminance value of the white light generated by the energized EL panel by no more than 30%.

8. The backlit display assembly of claim 6 further comprising a masking layer oriented between the to the optical interface layer and the imaged layer, wherein the masking layer is opaque to visible light, and wherein the masking layer covers a portion of the light transmission layer to selectively block the emission of light to the image layer.

9. The backlit display assembly of claim 1, wherein the backlit display assembly is conformable and flexible to permit conformable attachment to the predetermined topographical features.

10. The backlit display assembly of claim 1, wherein the display assembly is conformable and flexible to permit attachment to curved substrates, corrugated substrates, flexible substrates, and/or substrates with irregular surfaces defined by sharply raised areas.

11. The backlit display assembly of claim 1 further comprising an outermost, optically transparent overlaminate layer.

12. The display assembly of claim 1, wherein the image layer possesses a CIE color value of about x≈0.3 and y≈0.3 in both the energized and non-energized states.

13. A method for producing backlit, true color day-night graphic display, the method comprising:
(a) obtaining flexible electroluminescent panel operable to emit light, the panel including an electroluminescent layer including a phosphor component, and a light transmission layer operable to permit the transmission of light therethrough, wherein:
the panel is operable in an illuminated state and a non-illuminated state,
in the illuminated state, the light transmission layer appears white to a viewer of the panel, and
in the non-illuminated state, light from an external source reflects off of the phosphor component to cause a color shift in the light transmission layer such that the light transmission layer appears non-white to a viewer of the panel;
(b) applying a translucent optical interface layer over an outer surface of the light transmission layer, wherein the optical interface layer is operable to prevent the color shift and maintain the white appearance of the light transmission layer in both the illuminated and non-illuminated states; and
(c) applying an image layer to the optical interface layer.

14. The method of claim 13, further comprising (d) positioning a masking layer between the optical interface layer and the image layer, wherein the masking layer is opaque to visible light.

15. The method of claim 14 further comprising (e) applying an image to the image layer.

16. The method of claim 15 further comprising (f) applying an optically transparent protective layer over the image layer.

17. A method of selectively displaying true day/night graphics, the method comprising:
(a) obtaining a true color day-night backlit display assembly comprising:
a conformable and flexible electroluminescent panel including:
a first electrode layer defining an opaque side,
a second electrode layer including a light transmission layer, the second electrode defining a light-emitting side, and
an electroluminescent layer oriented between the first electrode
and second electrode,
wherein the electroluminescent panel is operable in a first, energized state, in which clean white light is produced, and a second, non-energized state, in which no light is produced, and wherein, in the energized state, the light transmission layer appears a first color to a viewer of the panel and, in the non-energized state, the light transmission layer appears a second color to the viewer of the panel, and
a translucent, flexible optical interface layer coupled directly to the light-transmission layer of the electroluminescent panel, wherein, when the panel is in its non-energized state, the optical interface layer shifts the color of the light transmission layer from the second color to the first; and
(b) coupling the non-light emitting side of the electroluminescent panel to a vehicle having a contoured surface such that the panel conforms to contours of the vehicle surface.

18. The method of claim 17 further comprising (c) selectively energizing the electroluminescent panel to alternate the panel from its illuminated state to its non-illuminated state.

19. The method of claim 18, wherein the vehicle comprises at least one of a curved surface, a corrugated surface, and an irregular surface defined by sharply raised areas.
